(19) United States
(12) Patent Application Publication
(10) Pub. No.: US 2008/0112347 A1
(43) Pub. Date: May 15, 2008

(54) METHOD AND APPARATUS TO PERFORM POWER CONSERVATION IN MULTIHOP NETWORKS

(75) Inventors: Hrishikesh Gossain, Apopka, FL (US); Stephen P. Emeott, Rolling Meadows, IL (US); Keith J. Goldberg, Casselberry, FL (US)

Correspondence Address: MOTOROLA, INC, 1303 EAST ALGONQUIN ROAD, IL01/3RD, SCHAUMBURG, IL, 60196, US

(73) Assignee: Motorola, Inc., Plantation, FL (US)

(21) Appl. No.: 11/559,217

(22) Filed: Nov. 13, 2006

(51) Int. Cl. G08C 17/00

(52) U.S. Cl. 370/311

(57) ABSTRACT

A method and apparatus is provided for power conservation in a node operating in a multihop network. The method includes determining whether a broadcast frame in a beacon interval intended for the node has been previously received by the node and remaining awake for reception of the broadcast frame in the beacon interval if the broadcast frame intended for the node has not been previously received by the node.

### FIELD OF THE INVENTION

The present invention generally relates to multihop networks and power conservation techniques therefor, and more particularly relates to power conservation in the presence of broadcast frames in such multihop networks.

### BACKGROUND OF THE DISCLOSURE

In recent years, communication through the use of ad hoc networks has become more prevalent. Ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network.

A mesh network is a form of an ad hoc network based on autonomous collections of mobile nodes that communicate with each other over wireless links having limited bandwidths. Individual nodes in a mesh network can perform routing functions, which enable a mesh network to be reconfigured around blocked paths or poor connections by “hopping” from one node to another until a destination is reached. A mesh network is thus described as self-healing, as it can still operate effectively even when particular nodes break down or leave the network.

In a multihop network, such as an ad hoc peer-to-peer network or a mesh network, operating in accordance with Institute of Electrical and Electronics Engineers (IEEE) 802.11 standards (such as IEEE 802.11a, 802.11b, or 802.11g), data is disseminated from one node or wired or wireless router (e.g., peer or mesh point) to another node in a hop by hop manner wherein each node is enabled to forward the data frame. This information could be in the form of a unicast message intended for a specific node or a broadcast message intended for many or all of the nodes.

As one or more of the nodes may be a portable electronic device operating on a limited power source such as a battery, section 11.2.2 of the 802.11 standard provides a mechanism for the nodes to perform power saving. The 802.11 Independent Basic Service Set (IBSS) mode power save operation specifies that each node “wakes up” (i.e. energizes elements of the node necessary to receive, demodulate and decode information) during the Announcement Traffic Indication Message (ATIM) window of the IBSS Beacon Interval (BI) to determine if the node has any unicast or broadcast frames to receive within the IBSS BI. The nodes use the ATIM management frames within the ATIM window to announce if there are any unicast or broadcast frames to transmit in the IBSS Beacon Interval. If the ATIM window indicates a unicast or broadcast frame intended for a node, the node remains awake (i.e., energized) for the remainder of the BI after the ATIM window to receive such frames.

In the 802.11 IBSS mode of operation, if a node has any broadcast frames during its power save operation, it sends a broadcast ATIM to inform all of its neighbors to remain awake for remainder of the BI. However, while a neighboring node might already have received this broadcast frame, the reception of the broadcast ATIM will force it to remain awake to receive the same broadcast frame again.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram of a multihop network for implementation of some embodiments of the present invention;

FIG. 2 is a timing diagram of IEEE 802.11 Independent Basic Service Set (IBSS) mode Beacon Intervals in accordance with some embodiments of the present invention;

FIG. 3 is a block diagram of an exemplary node of the multi hub network of FIG. 1 in accordance with some embodiments of the present invention;

FIG. 4 is a flowchart illustrating a power conservation method of the node of FIG. 3 in accordance with some embodiments of the present invention;

FIG. 5 is a flowchart illustrating a beacon interval transmission method of the node of FIG. 3 in accordance with some embodiments of the present invention;

FIG. 6 illustrates a structure for a broadcast duplicate detection information element in accordance with some embodiments of the present invention; and

FIG. 7 illustrates a structure for an action frame for broadcast duplicate detection in accordance with an alternate embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to power conservation in multihop networks. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of power conservation in multihop networks described herein. The non-processor circuits may include, but are not limited to, a radio receiver, a radio transmitter, signal drivers, clock circuits, power source circuits, and user input devices. As such, these functions may be interpreted as steps of a method to perform power conservation in multihop networks. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

A method and apparatus for power conservation in a node operating in a multihop network includes the steps of determining whether a broadcast frame in a beacon interval intended for the node has been previously received by the node and remaining awake for reception of the broadcast frame in the beacon interval if the broadcast frame intended for the node has not been previously received by the node.

The following detailed description of the invention is merely exemplary in nature and is not intended to limit the invention or the application and uses of the invention. Furthermore, there is no intention to be bound by any theory presented in the preceding background of the invention or the following detailed description of the invention.

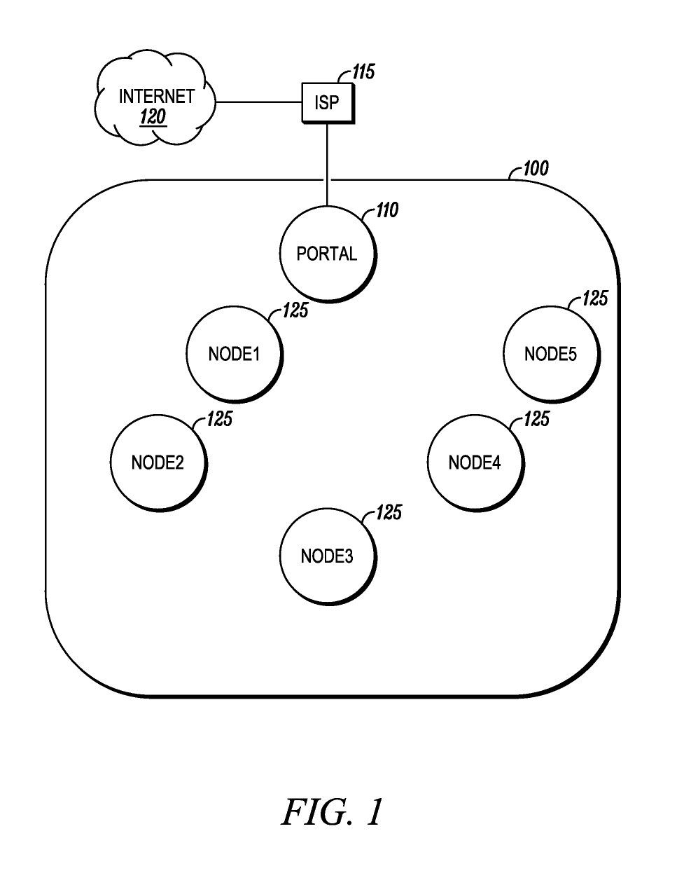

FIG. 1 illustrates a diagram of an exemplary multihop network 100 for the implementation of some embodiments of the present invention. The exemplary multihop network 100, for example, can be a mesh enabled architecture (MEA) network or an 802.11 network (i.e. 802.11a, 802.11b, or 802.11g) It will be appreciated by those of ordinary skill in the art that the communication network 100 in accordance with the present invention can alternatively comprise any packetized communication network. For example, the communication network 100 can be a network utilizing packet data protocols such as TDMA (time division multiple access), GPRS (General Packet Radio Service) and EGPRS (Enhanced GPRS). The multihop network 100, as illustrated, includes a portal 110 operatively coupled via a wired connection to an internet service provider 115 and thence to the internet 120. The portal 110 provides wireless communication of information to multiple nodes 125 (commonly referred to as nodes) within the multi-hop network 100 as data frames in accordance with standards for IEEE 802.11 networks such as 802.11a, 802.11b, or 802.11g networks. Each of the nodes 125 further disseminates the information to neighboring nodes 125 in a hop by hop manner wherein each node 125 is enabled to forward the data frame. In this manner, the information is forwarded to all of the nodes 125 in the multihop network 100. This information could be in the form of a unicast message intended for a specific node 125 or a broadcast message intended for many or all of the nodes 125.

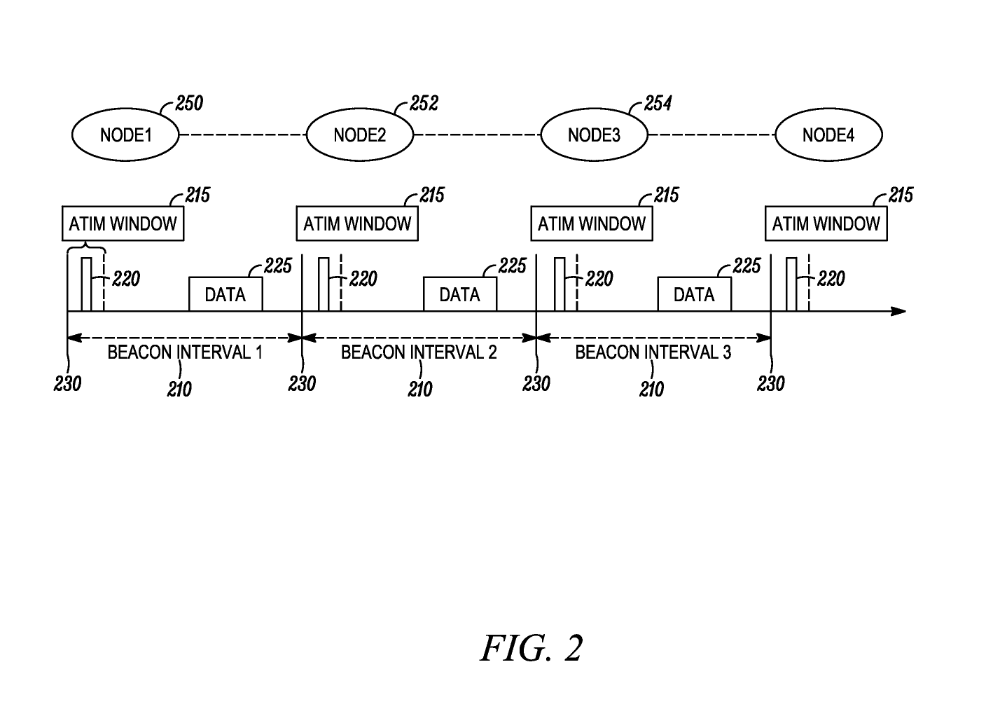

Referring to FIG. 2, a timing diagram 200 depicts an ad hoc transmission scheme for the multihop network 100 in accordance with IEEE 802.11 having a plurality of predetermined beacon intervals 210, each of the beacon intervals 210 including an Announcement Traffic Information Message (ATIM) window 215. The ATIM window 215 includes one or more ATIM announcements 220 and the remainder of the beacon interval 210 includes one or more frames of data 225. The IEEE 802.11 standard specification specifies a synchronized Power Save Mode for one hop ad hoc transmission schemes. In the Independent Basic Service Set (IBSS) mode of operation of 802.11 the nodes 125 are synchronized via a distributed algorithm performed by all the members of the IBSS. An IBSS is characterized by the beacon interval 210 which includes Beacon and Probe Response frames. The beacon interval 210 is typically one hundred milliseconds (msec) and defines a target beacon transmission time (TBTT) 230. At every TBTT 230, the nodes 125 compete for sending beacon frames 225. To send one or more frames of data 225, each node 125 suspends decrementing their backoff timers, calculates a new random delay, and starts decrementing the random delay timers. The backoff timers and random delay timers measure predetermined delay time intervals, the node not transmitting information during this time interval, to allow the other nodes 125 time to transmit information. A node 125 sends a beacon frame of data 225 if the random delay timer expires and no beacon frame 225 has been detected during the delay period. Each beacon frame 225 carries information about the sending node's 125 timestamp and the beacon interval 210. At each TBTT 230, all nodes 125 compete to send beacons and remain awake for the duration of the ATIM window 215, the ATIM window being typically ten msec. During the ATIM window 215, the nodes 125 that have messages to send use ATIM frames 220 to transmit frame identification information informing destination nodes 125 that a data frame 225 will follow. A unicast data frame 225 is preceded by a unicast ATIM announcement 220 while a broadcast data frame 225 is preceded in the ATIM window 215 by a broadcast ATIM announcement 220. After the expiration of the ATIM window 215, only the nodes 125 transmitting frames 225 during the beacon interval 210 and the nodes 125 that have determined they have frames 225 to receive remain awake; all other nodes 125 conserve power by switching to a low power mode until the next TBTT 230.

When a unicast ATIM announcement 220 is detected, a node 125 determines whether a unicast data frame 225 is intended for the node (i.e., whether the node 125 needs to remain awake to receive the unicast data frame 225) in response to information in the unicast ATIM announcement 220. In accordance with the present invention, a broadcast ATIM announcement 220 includes broadcast duplicate detection information so that a node 125 can determine not only whether the broadcast data frame 225 is intended for the node, but also whether the node 125 has previously received the broadcast data frame 225 in order to determine whether the node 125 is required to remain awake to receive the broadcast data frame 225. The node 125 determines whether it has previously received the broadcast data frame 225 in response to the broadcast duplicate detection information.

As mentioned above, in the multi-hop wireless network 100, broadcast and unicast messages are disseminated in data frames from one node 125 to another node 125 in a hop by hop manner, each node 125 being enabled to forward the data frame. In accordance with the embodiment of the present invention, a node 125 (NODE) is the original transmitter of a broadcast data frame. NODE1 is referred to as the broadcast originator node 250 and generates a broadcast announcement 220 including broadcast duplicate detection information. The broadcast duplicate detection information includes broadcast originator node information identifying the broadcast originator node 250 and a broadcast originator sequence number. The broadcast originator sequence number is a number uniquely identifying the broadcast frame in that the broadcast originator sequence number for the broadcast originator node 250 is incremented by one for each new broadcast data frame transmitted by the broadcast originator node 250.

In a hop by hop manner, the broadcast originator node 250 transmits the broadcast frame to neighboring nodes 125 during the first beacon interval 210. In the example depicted in FIG. 2, a neighboring node 252 (NODE2) receives the broadcast frame and, during the second beacon interval 210 retransmits the broadcast frame, NODE2 providing the same broadcast duplicate detection information in the broadcast announcement 220 of the second ATIM window 215. As described in more detail below, when NODE sees the broadcast duplicate detection information, NODE 250 will, in accordance with the embodiment of the present invention conserve power by not waking up to receive the previously stored broadcast frame. Further, when a neighboring node 125 (NODE3 254) transmits the broadcast frame in a third beacon interval 210, both NODE and NODE2 can conserve power during the third beacon interval by recognizing from the broadcast duplicate detection information that the broadcast frame has been previously received.

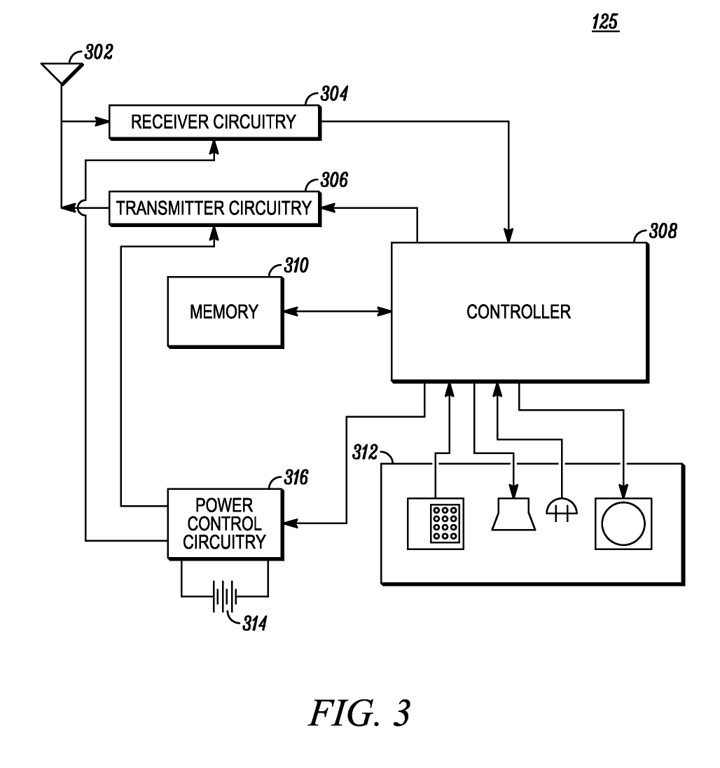

Referring to FIG. 3, a node for receiving radio frequency (RF) signals in accordance with some embodiments of the present invention is illustrated. The node 125 includes an antenna 302 for receiving and transmitting radio frequency (RF) signals. The antenna 302 is coupled to receiver circuitry 304 and transmitter circuitry 306 in a manner familiar to those skilled in the art. The receiver circuitry 304 demodulates and decodes received RF signals to derive information therefrom and is coupled to a controller 308 and provides the decoded information to the controller 308 for utilization by the controller 308 in accordance with the function(s) of the node 125. The controller 308 also provides information to the transmitter circuitry 306 for encoding and modulating information into RF signals for transmission from the antenna 302.

As is well-known in the art, the controller 308 is coupled to a memory 310 and a user interface 312 to perform the functions of the node 125. The memory 310 is coupled to the controller 308 and stores data and operational information for use by the controller 308 to perform the functions of the node 125. The user interface 312 may include any or all of a display, a keypad or keyboard and functional key inputs, a microphone, and/or a speaker. The display may be designed to accept touch screen inputs.

In accordance with some embodiments of the present invention, the node 125 is a mobile node 125 with a power source 314, such as a battery. The node 125 includes power control circuitry 316 to selectively provide power to elements of the node 125 such as the receiver circuitry 304 and the transmitter circuitry 306 in order to perform power conservation. The controller 308 provides receiver activation signals and transmitter activation signals to the power control circuitry 316 to selectively energize the receiver circuitry 304 and the transmitter circuitry 306, respectively. These activation signals are provided to the power control circuitry 316 for the time intervals necessary for the receiver circuitry 304 to receive RF signals intended for the node 125 and for the transmitter circuitry 306 to transmit RF signals to other nodes 125 in the multihop wireless network 100.

Further, in accordance with the embodiment of the present invention, the memory 310 stores node identification information for the other nodes 125 in the multihop network 100. Associated with the node identification information for each of the nodes 125 is a broadcast sequence number which is the highest previously received sequence number for broadcasts received from the other nodes 125 and is maintained and utilized for power conservation as described below. In addition, a broadcast sequence number for the node 125 itself is maintained in the memory 310 and incremented each time the node 125 transmits a broadcast data frame as the transmitting node 250.

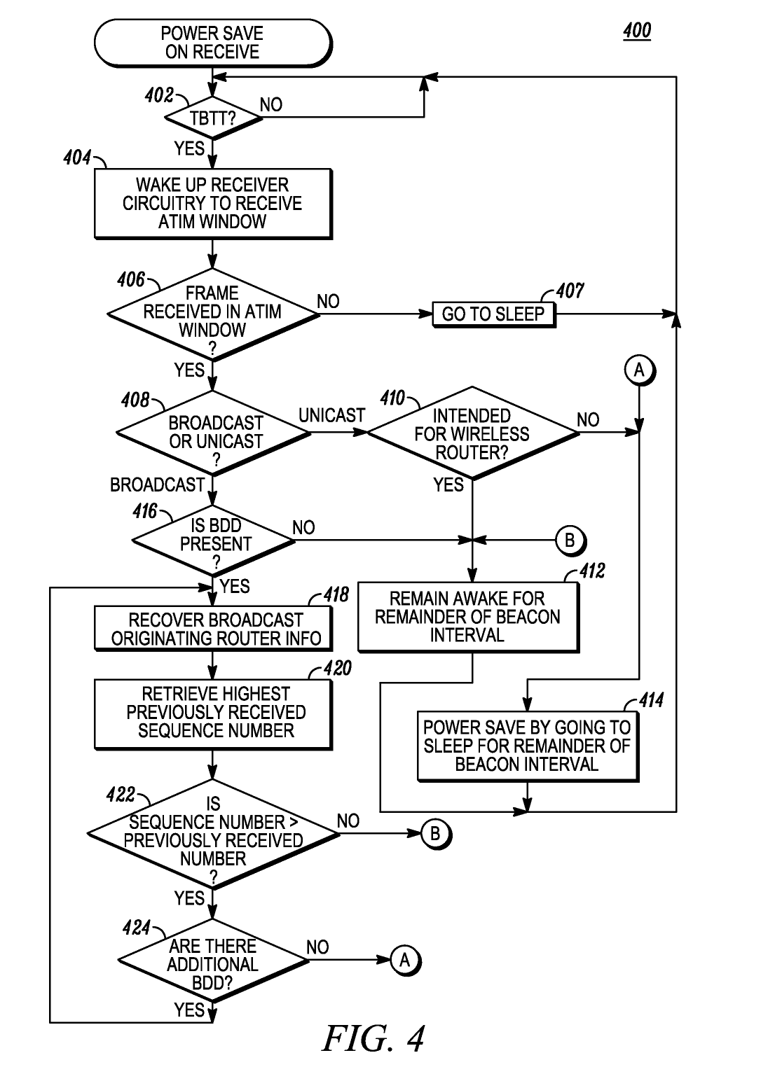

FIG. 4 is a flowchart 400 illustrating the power conservation operation of the controller 308 in accordance with some embodiments of the present invention during reception of a RF signal from the multihop network such as an IEEE 802.11 multihop network RF signal. The power conservation operation 400 initially determines whether it is the target beacon transmission time (TBTT) 402. At the TBTT 402, the controller 308 provides a receiver activation signal to the power control circuitry 316 to energize (i.e., ‘wakes up’) the receiver circuitry 304 for reception of the ATIM window 404. If no ATIM announcement frames 220 are received during the ATIM window 406, the controller 308 ceases providing the receiver activation signal to the power control circuitry 316 so that the receiver circuitry 304 goes to ‘sleep’ (i.e., goes into a power conservation mode) 407 and processing returns to await the next TBTT 402.

If an announcement frame is detected in the ATIM window 406, the controller 308 determines 408 whether the announcement frame 220 includes frame identification information identifying whether a data frame 225 in the beacon interval 230 is a unicast frame intended for the node 125 or a broadcast frame intended for the node 125. In other words, the controller 308 determines whether the announcement frame 220 is a unicast ATIM announcement or a broadcast ATIM announcement 408.

When the controller 308 determines that the announcement frame 220 is a unicast ATIM announcement 408 indicating a unicast data frame 225 will be transmitted in the beacon interval 210, the controller 308 examines the frame identification information to determine 410 whether the unicast data frame 225 is intended for the node 125. If the unicast data frame 225 is intended 410 for the node 125, the controller 308, at the end of the ATIM window 210, continues to provide the receiver activation signal to the power control circuitry 316 causing the receiver circuitry 304 to remain ‘awake’ 412 for the remainder of the beacon interval 210. Processing then returns to detect 402 the next TBTT 230.

If, on the other hand, the unicast data frame 225 is not intended 410 for the node 125, the controller 308, at the end of the ATIM window 210, ceases providing the receiver activation signal to the power control circuitry 316 causing the receiver circuitry 304 to go to ‘sleep’ 414 for a remainder of the beacon interval 210, thereby power saving for the remainder of the beacon interval 210. Processing then returns to detect 402 the next TBTT 230 to ‘wake up’ 404 for the next ATIM window 210.

In accordance with some embodiments of the present invention, when the controller 308 determines that the announcement frame 220 is a broadcast ATIM announcement 408 indicating a broadcast data frame 225 will be transmitted in the beacon interval 210, the controller 308 examines the frame identification information to determine broadcast duplicate detection information is present therein 416. If no broadcast duplicate detection information is present in the frame identification information 416, the controller 308, at the end of the ATIM window 210, continues to provide the receiver activation signal to the power control circuitry 316 causing the receiver circuitry 304 to remain ‘awake’ 412 for the remainder of the beacon interval 210 to receive the broadcast data frame 225 in accordance with conventional 802.11 operation. Processing then returns to detect 402 the next TBTT 230.

When broadcast duplicate detection information is present in the frame identification information 416, the controller 308 determines whether the broadcast frame has been previously received by the node 125 by recovering broadcast originator node information and a broadcast originator sequence number from the broadcast duplicate detection information 418. The broadcast originator node information identifies the transmitting node 250 (FIG. 2) that originated transmission of the broadcast data frame. The broadcast originator sequence number identifies the broadcast frame uniquely from other broadcast frames transmitted by the transmitting node 250.

The controller 308 then retrieves 420 from the memory 310 a highest previously received sequence number associated with the transmitting node 250 identified by the originator identification information. If the originator sequence number received in the broadcast announcement 220 which identifies the originator sequence number of the broadcast frame 225 is greater than the stored highest previously received sequence number retrieved 422, the controller 308, at the end of the ATIM window 210, continues to provide the receiver activation signal to the power control circuitry 316 causing the receiver circuitry 304 to remain ‘awake’ 412 for the remainder of the beacon interval 210. Processing then returns to detect 402 the next TBTT 230.

If, on the other hand, the originator sequence number received in the broadcast announcement 220 is not greater than the stored highest previously received sequence number retrieved 422, the broadcast data frame has been previously received by the node 125. If there is no additional broadcast duplicate detection information 424, the controller 308 can, in accordance with the embodiment of the present invention, power save 414 for the remainder of the beacon interval 210 by ceasing to provide the receiver activation signal to the power control circuitry 316 after the end of the ATIM window 210, causing the receiver circuitry 304 to go to ‘sleep’ for a remainder of the beacon interval 210. Processing then returns to detect 402 the next TBTT 230 to ‘wake up’ 404 for the next ATIM window 210.

If there is additional broadcast duplicate detection information 424 indicating that there are additional broadcast data frames 225 being transmitted in the beacon interval 210, processing returns to step 418 to recover broadcast originator node information and a broadcast originator sequence number from the broadcast duplicate detection information for the additional broadcast data frames 225. In this manner, the controller 308 will provide the receiver activation signal to the receiver circuitry 304 for the remainder of the beacon interval 210 after the ATIM window 215 if there are any broadcast data frames in the remainder of the beacon interval 210 that have not been previously received by the node 125. Thus, additional power conservation can be realized in accordance with embodiments of the present invention without decreasing the reliability of reception of broadcast data frames.

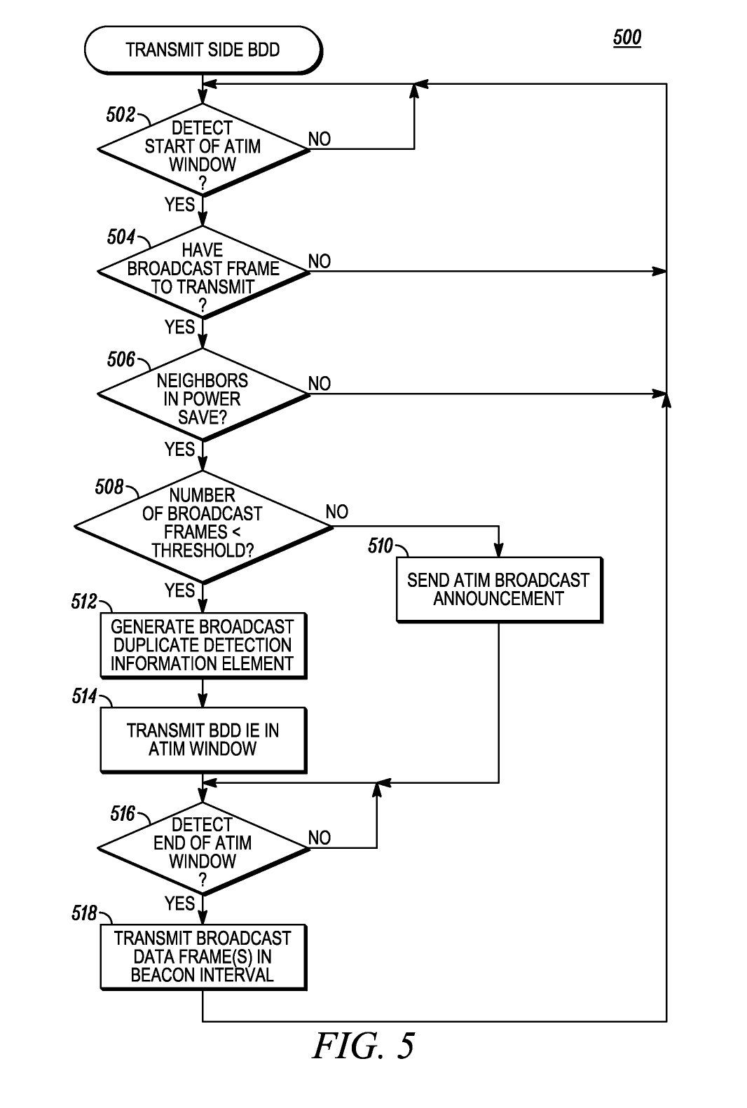

Referring to FIG. 5, a flowchart 500 illustrating the beacon interval transmission operation of broadcast information of the controller 308 in accordance with some embodiments of the present invention initially detects 502 the start 230 of an ATIM window 215 of a beacon interval 210. When the start of the ATIM window 215 is detected 502, the controller 308 determines 504 whether the node 125 has any broadcast information for transmission to the multihop network 100. The controller 308 next determines whether any of the neighboring nodes 125 are in power save mode 506 (i.e., not transmitting any announcement frames 220 in the ATIM window 215).

When the controller 308 has broadcast information for transmission 504 and the neighboring nodes 125 are in power save mode 506, the controller 308 determines whether the broadcast information for transmission includes a number of distinct broadcast messages for transmission as individual data frames 225 less than a predetermined broadcast message threshold 508. If the broadcast data frames 225 queue size of the node 125 is larger than the predetermined broadcast message threshold, the length of the broadcast duplicate detection information for insertion in the ATIM window 215 in accordance with some embodiments of the present invention may become disadvantageous because of the additional overhead information in the ATIM window 215 and the increased chances of having at least one new broadcast frame in information. Accordingly, when the broadcast information for transmission includes a number of distinct broadcast messages greater than or equal to the predetermined broadcast message threshold 508, a conventional broadcast announcement 220 without any broadcast duplicate detection information is provided 510 by the controller 308 to the transmitter circuitry 306 for transmission in the ATIM window 215 and processing returns to await detection 510 of the start of the next ATIM window 215.

When the broadcast information for transmission includes a number of distinct broadcast messages less than the predetermined broadcast message threshold 508, a broadcast duplicate detection information element (IE) is generated 512 by the controller 308 for use by neighboring nodes 125 to determine within the ATIM window 215 whether the broadcast message has been previously received. In accordance with the embodiment of the present invention, the broadcast duplicate detection IE includes originating node information identifying the node 250 that originally transmitted the broadcast message and an originator sequence number, the originator sequence number being greater than any sequence number for broadcast messages previously transmitted by the originating node 250. If the node 125 generating the broadcast duplicate detection IE 512 is the originating node, the controller 308 retrieves a broadcast sequence number associated with the node 125 from the memory 310 and generates the originator sequence number to be equivalent to the stored broadcast sequence number plus one. In addition, the controller stores the generated sequence number in the memory 310 as the broadcast sequence number associated with the node 125.

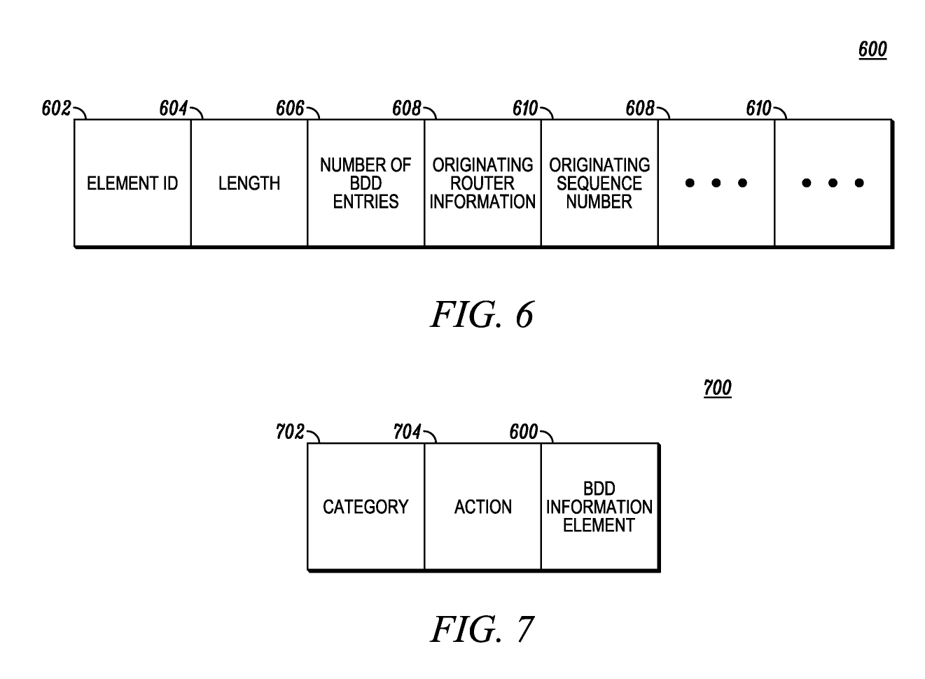

The controller 308 then provides 514 the broadcast duplicate detection IE to the transmitter circuitry 306 during the ATIM window 215 while providing a transmitter activation signal to the power control circuitry 316 to transmit the broadcast announcement 220 to the multihop network 100. In accordance with one embodiment of the present invention, a broadcast duplicate detection IE 600 can be constructed as illustrated in FIG. 6 and integrated into an IEEE 802.11 ATIM management frame. The broadcast duplicate detection IE 600 includes an information element identification 602, the length of the broadcast duplicate detection IE 604, the number of broadcast duplicate detection entries in the information element 606 and the originating node information 608 and originator sequence number 610 for each broadcast duplicate detection message.

Alternatively, as illustrated in FIG. 7, instead of being integrated into an ATIM management frame, the broadcast duplicate detection IE could be generated 512 as an 802.11 Action Frame 700 and transmitted 514 during the ATIM window 215. Using the Action Frame 700 does not require inserting the broadcast duplicate detection IE within the structure of an ATIM management frame. The Action Frame 700 includes a category field 702 and an action filed 704 followed by the broadcast duplicate detection IE 600.

Additionally, the ATIM management frame format could be reused to include one of the broadcast duplicate detection elements. This is particularly useful when a node 125 has only one broadcast frame 225 to transmit. In this case, the originating node information is included as the originator address in the Address 3 or Basic Service Set ID (BSSID) field of the ATIM management frame and the originator sequence number information is included in the sequence control field of the ATIM management frame.

Returning to FIG. 5, after transmitting 514 the broadcast announcement 220 to the multihop network 100, the controller 308 awaits detection 516 of the end of the ATIM window 220. After detection 516 of the end of the ATIM window 220, the controller 308 provides 518 the broadcast information to the transmitter circuitry 306 during a remainder of the beacon interval 210 while providing a transmitter activation signal to the power control circuitry 316 to transmit the one or more broadcast data frames 225 to the multihop network 100. Processing then returns to await detection 510 of the start of the next ATIM window 215.

Thus it can be seen that a method and apparatus have been disclosed which advantageously provides additional power conservation during IEEE 802.11 wireless communications in a multihop network 100. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A method for power conservation in a node operating in a multihop network, the method comprising the steps of:
determining whether a broadcast frame in a beacon interval intended for the node has been previously received by the node; and
power saving during the beacon interval by going to sleep when the broadcast frame intended for the node has been previously received by the node.

2. The method in accordance with claim 1 wherein the determining step comprises the step of determining whether the broadcast frame in the beacon interval intended for the node has been previously received by the node in response to broadcast duplicate detection information.

3. The method in accordance with claim 2 wherein the broadcast duplicate detection information includes an originating node information and an originating node broadcast sequence number.

4. The method in accordance with claim 1 wherein the determining step comprises the steps of:
determining whether a frame in the beacon interval is a unicast frame intended for the node or a broadcast frame intended for the node; and
in response to determining that the frame in the beacon interval is a broadcast frame intended for the node, determining whether the broadcast frame has been previously received by the node,
wherein the step of power saving comprises the step of going to sleep for a remainder of the beacon interval in response to the frame in the beacon interval not being a unicast frame intended for the node and not being a broadcast frame intended for the node that has not been previously received by the node.

5. The method in accordance with claim 4 wherein the beacon interval includes an Announcement Traffic Information Message (ATIM) window including an ATIM frame comprising frame identification information identifying whether a frame in the beacon interval is a unicast frame or a broadcast frame, and further identifying which node the frame is intended for,
the method further comprising activating the node to receive the ATIM frame during the ATIM window of the beacon interval,
wherein the step of determining whether a frame in the beacon interval is a unicast frame intended for the node or a broadcast frame intended for the node comprises determining whether a frame in the beacon interval is a unicast frame intended for the node or a broadcast frame intended for the node in response to the frame identification information, and
wherein the step of going to sleep for the remainder of the beacon interval comprises the node going to sleep for the remainder of the beacon interval after the ATIM window in response to determining that a unicast frame in the beacon interval is not a unicast frame intended for the node.

6. The method in accordance with claim 5 wherein the ATIM window is further includes broadcast duplicate detection information,
wherein the step of determining whether the broadcast frame has been previously received by the node comprises determining whether the broadcast frame has been previously received by the node in response to the broadcast duplicate detection information, and
wherein the step of going to sleep further comprises the step of the node going to sleep for the remainder of the beacon interval after the ATIM window in response to determining that a broadcast frame in the beacon interval is a broadcast frame intended for the node that has been previously received.

7. The method in accordance with claim 6 wherein the broadcast duplicate detection information includes broadcast originating node information including an originator identification information identifying a transmitting node that transmits the broadcast frame and an originator node sequence number identifying a unique broadcast frame,
wherein the step of determining whether the broadcast frame has been previously received by the node comprises the step of comparing the originator sequence number to a broadcast sequence number received previously from the transmitting node indicated by the originator identification information, and
wherein the step of going to sleep in response to determining that a broadcast frame has been previously received comprises going to sleep after the ATIM window for the remainder of the beacon interval when the originator sequence number is less than or equal to a broadcast sequence number previously received for the transmitting node indicated by the originator identification information.

8. A method for beacon interval transmission in a node operating in a multihop network, the method comprising the steps of:
determining whether the node has broadcast information for transmission to the multihop network;
generating an Announcement Traffic Information Message (ATIM) management frame in response to determining the node has the broadcast information for transmission to the multihop network, the ATIM management frame including broadcast duplicate detection information for a receiving node to determine whether the broadcast information has been previously received; and
transmitting the ATIM management frame to the multihop network within an ATIM window of a beacon interval and the broadcast information within a remainder of the beacon interval.

9. The method in accordance with claim 8 wherein the step of generating the ATIM management frame comprises generating the broadcast duplicate detection information including an originator node information, the originator node information identifying a node that originally transmitted the broadcast information.

10. The method in accordance with claim 9 wherein the step of generating the broadcast duplicate detection information further comprises generating an originator sequence number uniquely identifying the broadcast frame, the broadcast originator sequence number being greater than any sequence number for broadcast frames previously transmitted by the node that originally transmitted the broadcast information.

11. The method in accordance with claim 10 wherein the step of generating the ATIM management frame comprises generating the ATIM management frame to include the originator node information as an originator address information in an Address 3 or in a Basic Service Set IDentifier (BSSID) field of the ATIM management frame and to include the originator sequence number in an ATIM management frame sequence control field of the ATIM management frame.

12. The method in accordance with claim 9 wherein the step of generating the broadcast duplicate detection information comprises generating the originator node information to include information identifying the node in response to the node originating transmission of the broadcast information.

13. A method for beacon interval transmission in a node operating in a multihop network, the method comprising the steps of:
determining whether the node has broadcast information for transmission to the multihop network;
generating an action frame in response to determining the node has the broadcast information for transmission to the multihop network, the action frame including broadcast duplicate detection information for a receiving node to determine whether the broadcast information has been previously received; and
transmitting the action frame to the multihop network within an Announcement Traffic Information Message (ATIM) window of a beacon interval and the broadcast information within a remainder of the beacon interval.

14. A node operating in a multihop network, the node comprising:
receiver circuitry for receiving radio frequency (RF) signals from other nodes in the multihop network, the receiver circuitry demodulating and decoding the RF signals to recover information therefrom, the information configured to include a plurality of predetermined beacon intervals, each of the plurality of predetermined beacon intervals including a message window and one or more frames of data;
a controller coupled to the receiver circuitry to receive the information therefrom, the controller processing the information for utilization by the node;
a power source for providing power to elements of the node; and
power control circuitry coupled between the power source and the receiver circuitry for selectably energizing the receiver circuitry in response to a receiver activation signal, and
wherein the controller is coupled to the power control circuitry and provides a receiver activation signal thereto to energize the receiver circuitry to remain awake to receive one or more frames of data of one of the plurality of predetermined beacon intervals in response to the controller determining the one of the plurality of predetermined beacon intervals includes a frame of data which is a broadcast frame intended for the node that has not been previously received by the node.

15. The node in accordance with claim 14 wherein the controller determines whether the broadcast frame in the one of the plurality of predetermined beacon intervals intended for the node has been previously received by the node in response to an originating node information.

16. The node in accordance with claim 15 wherein the originating node information includes an originator identification information and an originator sequence number.

17. The node in accordance with claim 14 wherein the controller determines whether one of the one or more frames of data in the one of the plurality of predetermined beacon intervals is a unicast frame intended for the node or a broadcast frame intended for the node and, in response to determining that the one of the one or more frames of data in the one of the plurality of predetermined beacon intervals is a broadcast frame intended for the node, determines whether the broadcast frame has been previously received by the node, the controller providing the receiver activation signal to the power control circuitry for the one or more frames of data of the one of the plurality of predetermined beacon intervals in response to determining that one of the one or more frames of data in the one of the plurality of predetermined beacon intervals is one of a unicast frame intended for the node or a broadcast frame intended for the node that has not been previously received by the node.

18. The node in accordance with claim 17 wherein the message window is an Announcement Traffic Information Message (ATIM) window configured to provide frame identification information identifying whether a frame in the one of the plurality of predetermined beacon intervals is a unicast frame or a broadcast frame and identifying which node the frame is intended for and wherein the controller provides the receiver activation signal to the power control circuitry for the ATIM window of each of the plurality of predetermined beacon intervals, the controller continuing to provide the receiver activation signal to the power control circuitry for a remainder of the one of the plurality of predetermined beacon intervals to receive the one or more frames of data therein in response to determining that the frame identification information of the ATIM window of the one of the plurality of predetermined beacon intervals identifies that at least one of the one or more frames of data in the one of the plurality of predetermined beacon intervals is one of a unicast frame intended for the node or a broadcast frame intended for the node that has not been previously received by the node.

19. The node in accordance with claim 18 wherein the ATIM window includes a broadcast duplicate detection information, and wherein the controller determines whether the broadcast frame has been previously received by the node in response to the broadcast duplicate detection information.

20. The node in accordance with claim 19 further comprising a memory coupled to the controller and storing broadcast originator identification information and a highest previously received sequence number associated with each node in the multihop network wherein the broadcast duplicate detection information within the ATIM window includes a broadcast originator identification information identifying a transmitting node that transmits the broadcast frame and sequence number information identifying the originator sequence number of the frame and wherein the controller determines whether the broadcast frame has been previously received by the node in response to retrieving the stored highest previously received sequence number associated with the received broadcast originator information and comparing the stored highest previously received sequence number to the received originator sequence number of the broadcast frame to determine if the received originator sequence number of the broadcast frame is less than or equal to the stored highest previously received sequence number.

21. The node in accordance with claim 20 wherein the controller provides the receiver activation signal to the power control circuitry for energizing the receiver circuitry to receive the one or more frames of data of the one of the plurality of predetermined beacon intervals in response to the controller determining that the received originator sequence number of the broadcast frame in the one or more frames of data is higher than the stored highest previously received sequence number associated with the received broadcast originator information, the controller further providing the received originator sequence number to the memory for storage therein as the highest previously received sequence number associated with the received broadcast originator information.

22. The node in accordance with claim 14 further comprising transmitter circuitry coupled to the controller and encoding and modulating information received from the controller for transmission as RF signals to the multihop network, wherein the power control circuitry is coupled between the power source and the transmitter circuitry for selectably energizing the transmitter circuitry in response to a transmitter activation signal, and wherein the controller generates message information in response to determining the node has broadcast information for transmission to the multihop network, the controller further providing the message information and the broadcast information to the transmitter circuitry during one of the plurality of predetermined beacon intervals while providing the transmitter activation signal to the power control circuitry to transmit the message information and the broadcast information to the multihop network within the one of the plurality of predetermined beacon intervals, the message information transmitted within an Announcement Traffic Information Message (ATIM) window of the one of the plurality of predetermined beacon intervals and the broadcast information transmitted within one of the one or more frames of data of the one of the plurality of predetermined beacon intervals.

23. The node in accordance with claim 22 wherein the controller generates the message information including broadcast duplicate detection information for a receiving node to determine whether the broadcast information has been previously received.

24. The node in accordance with claim 23 wherein the controller generates the message information to include the broadcast duplicate detection information only if the controller determines that the node has broadcast information comprising less than a predetermined number of distinct broadcast messages for transmission to the multihop network.

25. The node in accordance with claim 23 wherein the controller generates the broadcast duplicate detection information including an originator node information and an originator sequence number of the broadcast frame, the originating node information identifying a node that originally transmitted the broadcast information, and the originator sequence number associated with the node that originally transmitted the broadcast information and identifying the number of broadcast frames transmitted thereby.

26. The node in accordance with claim 24 further comprising a memory storing a broadcast sequence number for a broadcast frame transmitted previous to the broadcast information and wherein the controller, in response to the node being originator of the broadcast frame, generates the originator node information to include information identifying the node as originally transmitting the broadcast frame and generates the sequence number to be equivalent to the stored broadcast sequence number plus one, the controller storing the generated sequence number in the memory as the broadcast sequence number.

27. The node in accordance with claim 23 wherein the controller generates the message information as one of an ATIM management frame including the broadcast duplication detection information or an action frame including the broadcast duplication detection information.
